(19) United States
(12) Patent Application Publication
(10) Pub. No.: US 2012/0068029 A1
(43) Pub. Date: Mar. 22, 2012

(54) Snowboard holder

(76) Inventor: Ryan Patrick Elvira, Valencia, CA (US)

(21) Appl. No.: 12/807,875

(22) Filed: Sep. 17, 2010

(51) Int. Cl. F16M 13/02

(52) U.S. Cl. 248/222.14

(57) ABSTRACT

A snowboard holder with a horizontally disposed rigid elongate member, a vertically disposed mounting bracket member, a pair of resilient wheels, a pair of wheel shafts and a pair of wheel retaining bolts. The mounting bracket member is centrally and fixedly attached to the horizontal elongate member. The wheel shafts are each fixedly attached to the elongate member; one wheel shaft toward the left end and one the wheel shaft toward the right end. The wheels are rotatably mounted on the wheel shafts. The wheel retaining bolts are screwed into mating threaded apertures located in the free end of each wheel shaft. A preferred embodiment includes the wheels are made of molded polyurethane.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of wall mounted holding devices and more specifically to a snowboard holder.

Snowboards have become a popular method of skiing down snow covered slopes. Rather than the traditional two sets of skis, a snowboard is a single wider ski, with two boot bindings removably attachable to the top surface of the board. Today's modern snowboards often have colorful graphics painted on their top surfaces. Snowboarders must store their boards in a safe manner which will not scratch or mare the board in any way. One way to safely store a board is to hang the board on a wall by some sort of mounting or holding means. The ideal holding means would not mar the board, and would allow the entire front surface of the board to be seen in an uninterrupted manner so that the artwork on the top surface of the board can be fully appreciated while hung on a wall in a home or office.

Other attempts at hanging skis, surfboards, skate boards or snowboards have been patented. These include patents:
U.S. Pat. No. 4,635,800
U.S. Pat. No. 4,878,585
U.S. Pat. No. 5,014,955
U.S. Pat. No. 5,305,897
U.S. Pat. No. 5,601,196
U.S. Pat. No. 5,826,908
U.S. Pat. No. 5,833,078
U.S. Pat. No. 6,045,100
U.S. Pat. No. 6,827,226
U.S. Pat. No. 6,935,517
U.S. Pat. No. 6,938,864
U.S. Pat. No. 7,374,051
   Some of the above listed patented designs use rollers in some way, to hold items. The last patent sited, U.S. Pat. No. 7,374,051 uses three rollers to try to trap a board. However, the application is for boards with parallel sides which require an articulating frame structure and a friction grip comprised more three or more rollers to hold the board in place. None of the prior art designs show a novel way to inexpensively hold a snowboard to a wall using only two rollers while allowing the entire front surface of the board to be seen without obstruction.

### BRIEF SUMMARY OF THE INVENTION

The primary object of the invention is to provide a snowboard holder that allows a user to easily and quickly hang a snowboard onto a vertical wall.

Another object of the invention is to provide a snowboard holder that is easy and inexpensive to manufacture.

Another object of the invention is to provide a snowboard holder that allows the entire surface of the board to be viewed in an unobstructed manner.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a snowboard holder comprising: a horizontally disposed rigid elongate member, a vertically disposed mounting bracket member, a pair of resilient wheels, a pair of wheel shafts and a pair of wheel retaining bolts. Said mounting bracket member fixedly attached to the center point of said horizontal elongate member, said mounting bracket having a mounting aperture, said wheel shafts each fixedly attached to said elongate member, one said wheel shaft toward the left end and one said wheel shaft toward the right end, said wheels rotatably mounted on said wheel shafts and said retaining bolts screwed into mating threaded apertures located at the free end of each wheel shaft.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front view of the invention in use.

FIG. 2 is a rear view of the invention in use.

FIG. 3 is a side view of the invention in use.

FIG. 4 is a front view of the invention.

FIG. 5 is a front view of an alternate embodiment of the invention.

FIG. 6 is an exploded perspective view of the invention.

FIG. 7 is an alternate embodiment of the elongate member of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

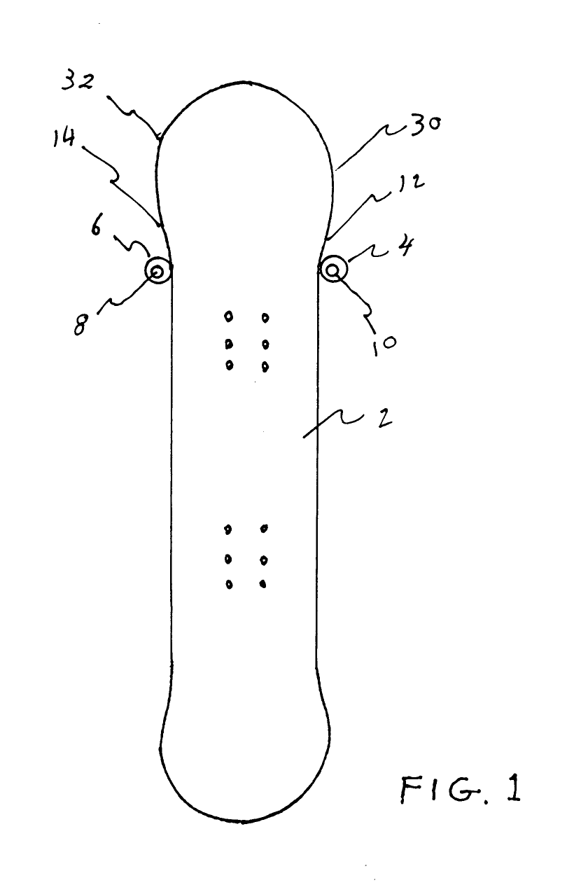

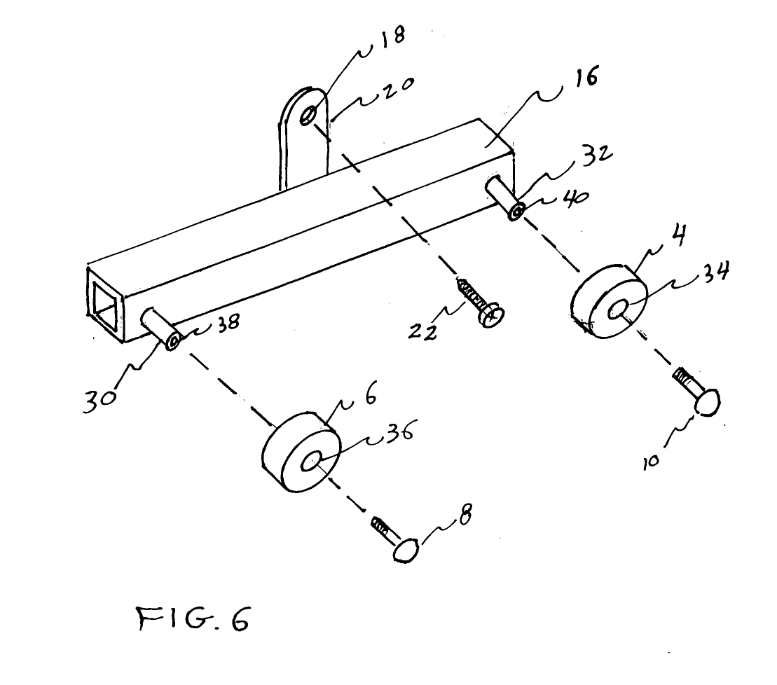

Referring now to FIG. 1 we see a front view of the present snowboard holder invention in use holding a standard snowboard 2. All standard snowboard shapes include parallel sides with a flared out portion 12, 14 located near the top and the bottom of the board 2. The present invention takes advantage of the flared out portion 12, 14 by placing wheels 4, 6 on either side of the snowboard 2 just before the flared out portion 12, 14 begins. In this way, the wheels 4, 6 act to hold the board 2 in place while mounted to a vertical wall surface. The consistency of the width of snowboards from manufacturer to manufacturer allows the present embodiment of snowboard holder to be made with the wheels fixed in place. However, if future designs of snowboards have different widths, variations of the present invention can be made so that the wheels 4, 6 can be placed in the appropriate location with respect to the new board shape. Additionally, an alternate embodiment of the present invention can include a plurality of aperture locations to attach the wheel shafts 30, 32 to accommodate a variety of snowboard widths within the same elongate member. The present design allows the board 2 to be easily and quickly hung or removed by a user. Additionally, the wheels 4, 6 do not interfere with viewing the front surface of the board 2, many of which have displayable artwork applied to them. Therefore the holder of the present invention can store the board 2 against a wall as well as use the board 2 as an art piece that can enhance the decor of a room where the board 2 is hung. The wheels 4, 6 are preferably the same as those used in standard skateboards. They tend to be made from molded polyurethane and are relatively inexpensive because of the high quantities manufactured each year. The wheels 4,6 are resilient and will not mar the sides of a snowboard. Additionally, the rotating nature of the skateboard wheels 4,6, which include ball bearings, allow the user to slide that board along the sides of the wheels 4, 6 which rotate as the board slides on them thereby further eliminating the chance of scratching or marring. Shaft retaining screws 8, 10 hold the wheels on wheel shafts 30, 32 as shown in FIG. 6.

Continuing with FIG. 6, the shafts 30, 32 are fixedly attached to the elongate member 16. In the present embodiment, the elongate member 16 is made from a one inch square tube made of rigid material such as aluminum. Shafts 30, 32 include threaded apertures 38, 40 that can accept retaining screws 8, 10 thereby holding the wheels 4, 6 in place. Vertical bracket 20 if fixedly attached to the elongate member in a standard way. Wall mounting screw 22 penetrates aperture 18 and then is screwed into a vertical wall surface as found in a standard home or office.

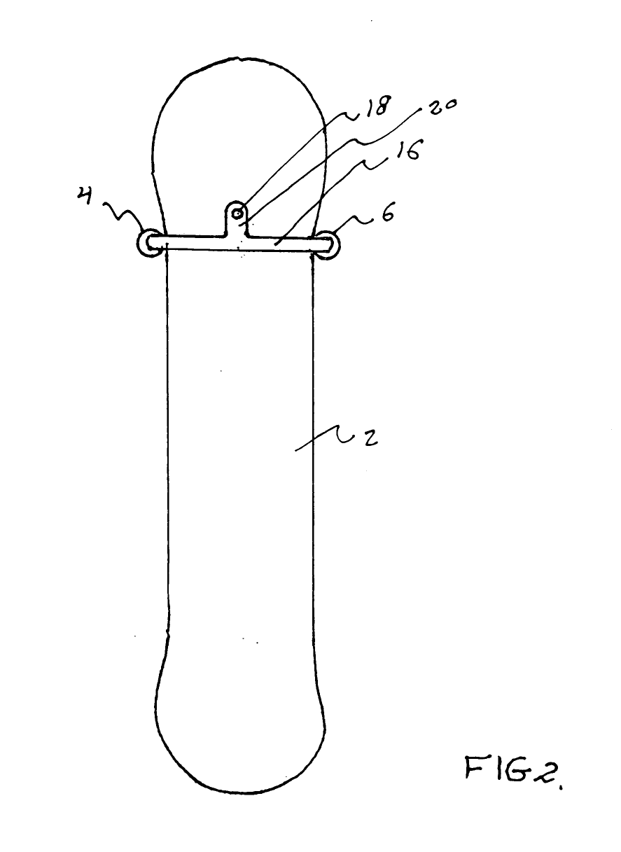

FIG. 2 shows a rear view of the snowboard holder in use. Elongate member 16 can be clearly seen and is sized to retain the left and right wheels 4, 6 at each end of the elongate member 16.

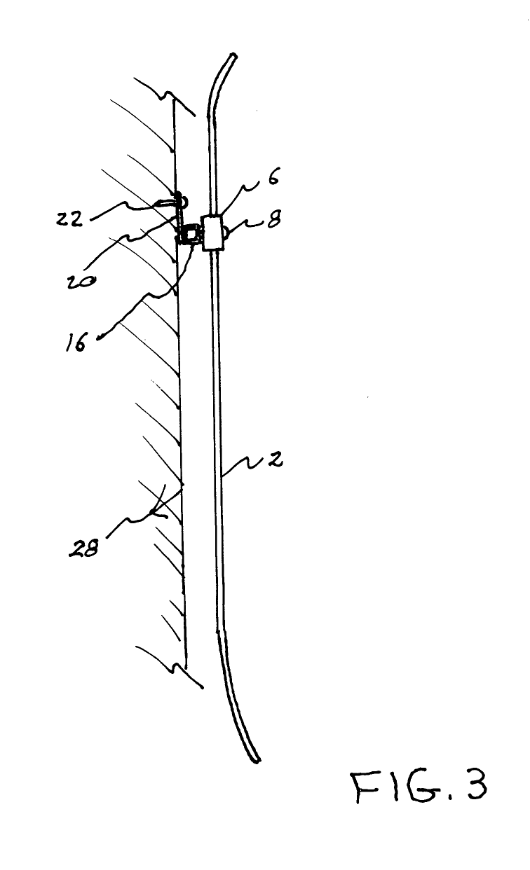

FIG. 3 is a side view of the present invention in use. Wheel 16 frictionally holds the side edge of the snowboard 2. Mounting screw 22 is shown to be retaining the vertical bracket 20 to the wall 28.

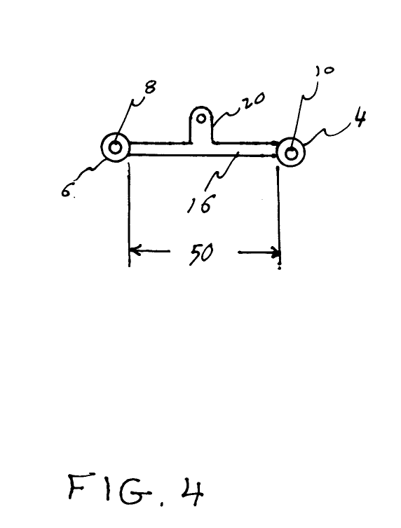

FIG. 4 shows a front view of the invention for clarity purposes. In the preferred embodiment, the wheels are sixty-five millimeters in diameter and thirty-five millimeters thick. The distance between the wheels 4, 6, as shown by dimension lines 50, is approximately thirteen inches. The vertical bracket 20 that extends from elongate member 16 is approximately two inches tall and one inch wide.

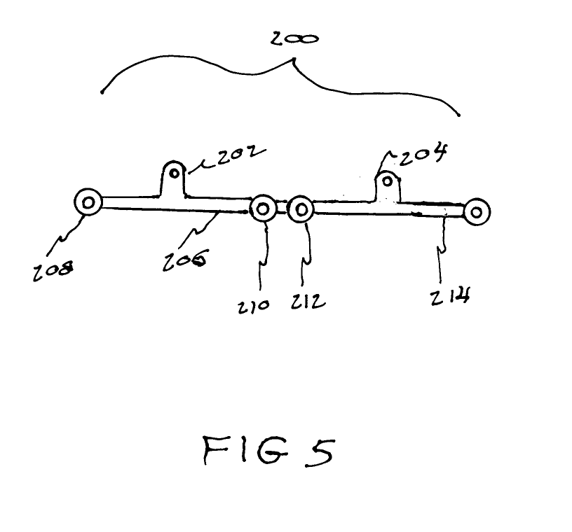

FIG. 5 shows an alternate embodiment of the invention 200 where two snowboards can be stored side by side. Two sets of wheels 208, 210 and 212, 214, attached to elongated member 206, each hold a standard snowboard in the same manner as in the first embodiment shown and described above. A pair of vertical brackets 202, 204 attach the holder 200 to the wall as described above. Obviously, variations on the present invention can be made to hold even more snowboards.

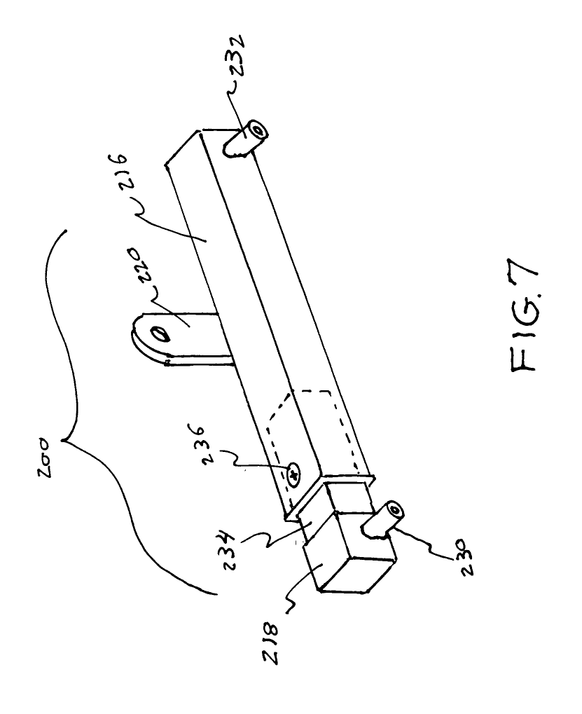

In an alternate embodiment shown in FIG. 7, the elongate assembly 200 includes an adjustable portion 218 whose attached extension member 234 can slide within tube 216 thereby allowing the user to adjust the distance between wheel shafts 230 and 232. Standard screw 236 holds extension member 234 in place. Hanging bracket 220 can also be loosened and slid to the left and tightened in a standard way to arrive at a new bisecting balance point. In this way, the present invention can be adjusted to accommodate snowboards manufactured at a future date that might be wider than the ones manufactured currently.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Snowboard Holder comprising:
a horizontally disposed rigid elongate member;
a vertically disposed mounting bracket member;
a pair of resilient wheels;
a pair of wheel shafts;
a pair of wheel retaining bolts;
said mounting bracket member fixedly and centrally attached to said horizontal elongate member;
said mounting bracket having a mounting aperture;
said wheel shafts each fixedly attached to said elongate member, one said wheel shaft toward the left end and one said wheel shaft toward the right end;
said wheels rotatably mounted on said wheel shafts and
said retaining bolts screwed into mating threaded apertures centrally located in the free end of each wheel shaft.

2. Snowboard holder as claimed in claim 1 wherein said wheels are made of molded polyurethane.

3. Snowboard holder as claimed in claim 1 wherein said wheels are approximately sixty-five millimeters in diameter and thirty-five millimeters wide.

4. Snowboard holder as claimed in claim 1 wherein the distance between said wheels is approximately ten and three eighths inches.

5. Snowboard holder as claimed in claim 1 wherein said elongate member is approximately fourteen inches long.

6. Snowboard holder as claimed in claim 1 wherein said vertically disposed mounting bracket member extends above said elongate member approximately two inches and is approximately one inch wide.

7. A second embodiment of said snowboard holder as claimed in claim 1 wherein said elongate member is longer than said embodiment as claimed in claim 1 and can hold two or more sets of said wheel shafts and said wheels.

8. A third embodiment of said snowboard holder as claimed in claim 1 wherein said elongate member includes an extension member that can be adjusted and locked in place by standard means to accept snowboards of varying widths.
